(19) United States
(12) Patent Application Publication
(10) Pub. No.: US 2013/0000564 A1
(43) Pub. Date: Jan. 3, 2013

(54) Refillable Pet Treat

(76) Inventors: Gordon Haggott Beckhart, Colorado Springs, CO (US); Stella Marie Beckhart, Colorado Springs, CO (US)

(21) Appl. No.: 13/175,462

(22) Filed: Jul. 1, 2011

(51) Int. Cl. A01K 29/00

(52) U.S. Cl. 119/710

(57) ABSTRACT

The invention is directed to a refillable pet treat that has a rigid housing with a first face and a second face. A first cavity is in the first face of the rigid housing. A second cavity is formed in the first cavity. A solid surface forms the second face. The rigid housing is in the shape of a bone. The owner spreads their choice of dog food or other spreadable food in the first and second cavities. This allows the owner to select a low calorie food their pet likes. It also allows the owner to select a pet food that does not cause any adverse reaction in their pet. The treat may be frozen after the food is spread into the cavities. This increases the time it takes the pet to extract the food, which works their jaw calming the dog while significantly reducing the cost of the treat.

### RELATED APPLICATIONS

Not Applicable

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Pet treats and dog/cat treats in particular have become very popular. Treats on the market are often composed of high caloric combinations of meat, meat by products, and sweeteners. Ingredient information is difficult to find and understand, and information on calories is even more difficult to find.

Pet treats are also relatively expensive especially when you consider how quickly the pet consumes the treat and potential adverse health effects. Some common beef-like treats are 20 cents each and last 8 seconds. This comes out to over $1 per minute of enjoyment and at a high cost in terms of calories. Pets are now often overweight causing the same adverse health effects that humans feel: arthritis, diabetes, stress on joints, backs, and cardiovascular issues. Many pet treats also have a surprising level of sugar adding to potential tooth decay.

There have been attempts to solve these problems, including flexible balls having slit into which the owner inserts a treat. Because the ball is flexible, the slit closes after the owner inserts the treat into the ball. This forces the dog to maneuver the ball to open the slit to get the treat. Unfortunately, this limits the treats that can be used and dogs often become bored and ignore the ball, defeating the purpose of the treat. Another solution is a ball with an opening into which the owner can place spreadable food. While this reduces the cost of the treat, and works the pets dexterity, it does not work the dog's jaws. In addition, this treat toy has a pliable exterior that can be destroyed by the dog. Frozen pet treats made from broth of different flavors have also been created, which do have lower calories. These tend to be messy and shatter when the dog chews on them.

Thus there exists a need for a refillable treat that costs less money per serving, has fewer calories, is a known healthy choice for the pet, and lasts for minutes rather than seconds.

### BRIEF SUMMARY OF INVENTION

A refillable pet treat that overcomes these and other problems has a rigid housing with a first face and a second face. A first cavity is in the first face of the rigid housing. A second cavity is formed in the first cavity. A solid surface forms the second face. In one embodiment the rigid housing is in the shape of a bone. The owner spreads their choice of dog food or other spreadable food in the first and second cavities. This allows the owner to select a low calorie food their pet likes. It also allows the owner to select a pet food that does not cause any adverse reaction in their pet. In one embodiment, the treat is frozen after the food is spread into the cavities. This increases the time it takes the pet to extract the food, which works their jaw calming the dog while significantly reducing the cost of the treat.

### BRIEF DESCRIPTION OF THE SEVERAL VIEWS OF THE DRAWINGS

FIG. 1 is a perspective view of a refillable pet treat in accordance with one embodiment of the invention;

FIG. 2 is a front view of the refillable pet treat in accordance with one embodiment of the invention;

FIG. 3 is a side view of the refillable pet treat in accordance with one embodiment of the invention;

FIG. 4 is a perspective cross sectional view of the refillable pet treat in accordance with one embodiment of the invention; and

FIG. 5 is a cross sectional view of the refillable pet treat in accordance with one embodiment of the invention.

### DETAILED DESCRIPTION OF THE INVENTION

The invention is directed to a refillable pet treat that has a rigid housing with a first face and a second face. A first cavity is in the first face of the rigid housing. A second cavity is formed in the first cavity. A solid surface forms the second face. In one embodiment the rigid housing is in the shape of a bone. The owner spreads their choice of dog food or other spreadable food in the first and second cavities. This allows the owner to select a low calorie food their pet likes. It also allows the owner to select a pet food that does not cause any adverse reaction in their pet. In one embodiment, the treat is frozen after the food is spread into the cavities. This increases the time it takes the pet to extract the food, which works their jaw calming the dog while significantly reducing the cost of the treat.

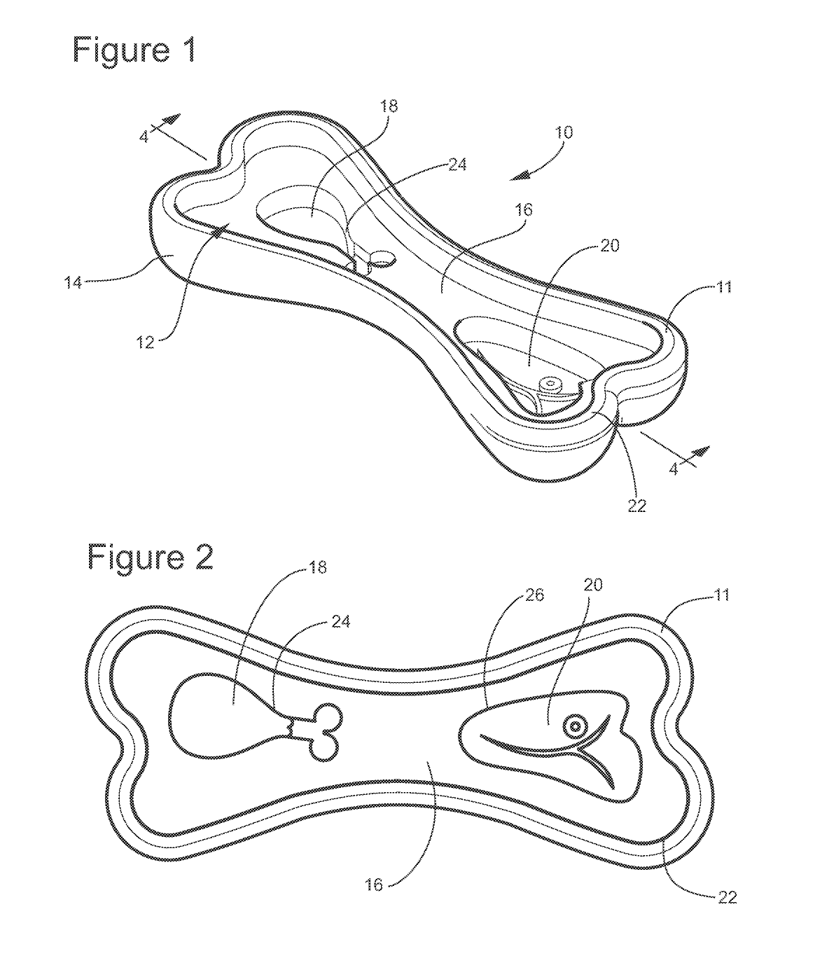

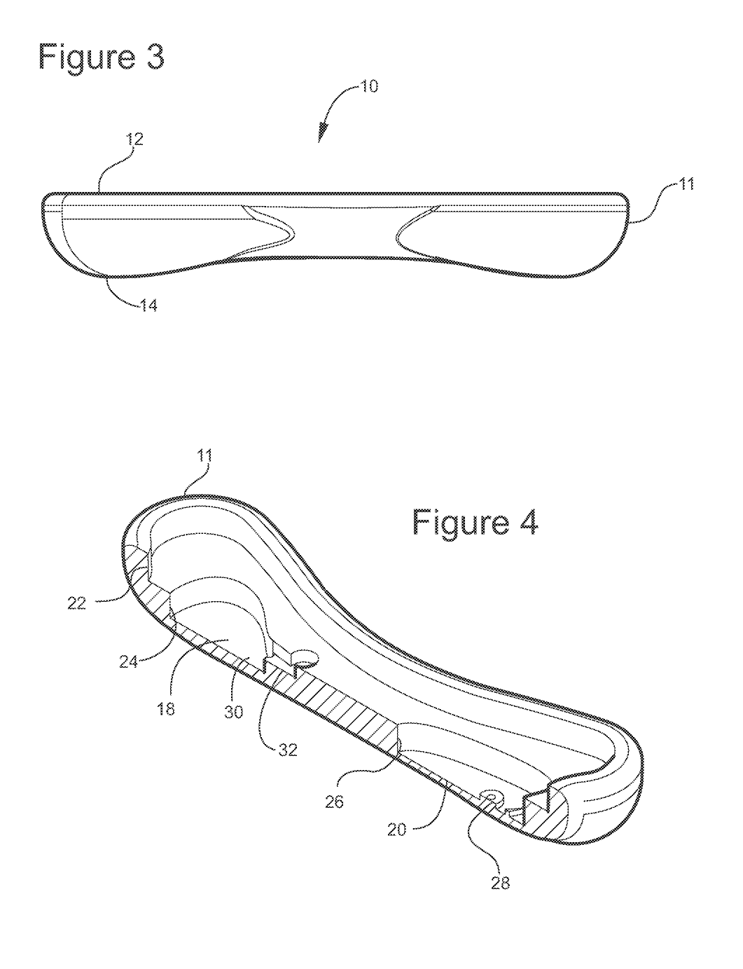

FIG. 1 is a perspective view of a refillable pet treat 10 in accordance with one embodiment of the invention. The pet treat 10 has a rigid housing 11 with a first face 12 and a second face (back) 14 (as best seen in FIG. 3). The housing 11 is made of a pet safe material, such as a rigid plastic, for instance nylon. A first cavity 16 is formed in the first face 12. A second cavity 18 is formed in the first cavity 16. This cavity is in the shape of a drumstick. A third cavity 20 is formed in the first cavity 16. In one embodiment, the rigid housing 11 is in the form of a dog bone. In one embodiment, the first cavity 16 has a perimeter 22 to area (area enclosed by perimeter 22) ratio that is greater than a square or circle with the same perimeter. This is important because it ensures plenty of perimeter to hold the spreadable pet food. It also ensures that the pet has to work in order remove the pet food from the cavity 16. The second cavity 18 also has a perimeter 24 to area (area enclosed by perimeter 24) ratio that is greater than a square or circle with the same perimeter. The cavity 18 within the cavity 16 also increases the effort the dog has to expend to remove the food. Similarly, the third cavity 20 has a perimeter 26 to area (area enclosed by perimeter 26) ratio that is greater than a square or circle with the same perimeter. There are a number of features 28 in the bottom of the third cavity 20 that also tend to hold the food.

Note that while the invention is shown with the second cavity inside the first cavity, cavities may be formed in both faces of the housing 11. The advantage of having the cavities all formed in one face is that it makes it easier to freeze the treat without making a mess.

FIG. 2 is a front view of the refillable pet treat 10 in accordance with one embodiment of the invention. The relation of the cavities 16, 18, & 20 are more clearly shown. FIG. 3 is a side view of the refillable pet treat 10 in accordance with one embodiment of the invention. This view shows that first face 12 is flat while the second face 14 has the shape of a bone.

FIG. 4 is a perspective cross sectional view of the refillable pet treat 10 in accordance with one embodiment of the invention. This view shows that cavity 18 actually has two levels, 30 & 32. The different levels increase the time the pet has to spend removing the pet food.

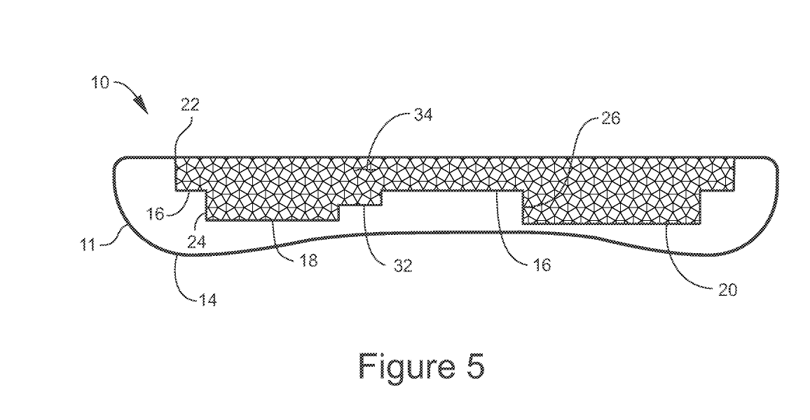

FIG. 5 is a cross sectional view of the refillable pet treat 10 in accordance with one embodiment of the invention. This view shows pet treat 10 filed with a spreadable pet food 34. The pet treat 10 may be placed in the freezer after being filled with pet food 34 to freeze the pet food. This increase the time and effort that it takes the pet to remove the food increasing their enjoyment.

The device is inexpensive because it is made of a durable pet safe material that can be refilled and reused multiple times. The treat is also inexpensive because it uses a small amount of canned food. The treat is a healthy choice because it can utilize the same food the owner has carefully chosen and the pet is used to eating. The system takes the pet a long time to consume relative to standard treats. In one example, a pre-packaged treat costs an average of 20-cents and a small dog can gulp it down in 8 seconds or less. This device allows a pet owner to provide a healthy treat for pennies that will last many minutes.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A refillable pet treat, comprising:
a rigid housing having a first face and a second face;
a first cavity in the first face of the rigid housing;
a second cavity in the first cavity; and
a solid surface on the second face.

2. The refillable pet treat of claim 1, further including a third cavity in the first cavity.

3. The refillable pet treat of claim 1, wherein a longitudinal cross section of the rigid housing has a perimeter to area ratio that is greater than a square with the perimeter of the rigid housing.

4. The refillable pet treat of claim 1, wherein the first cavity has a depth less than a housing depth of the rigid housing.

5. The refillable pet treat of claim 4, wherein the first cavity has a shape equivalent to a shape formed by a longitudinal cross section of the rigid housing.

6. The refillable pet toy of claim 1, wherein the second cavity has a perimeter to area ratio that is greater than a circle with the perimeter of the second cavity.

7. The refillable pet toy of claim 1, further including a pet food filling the second cavity.

8. The refillable pet toy of claim 7, further including the pet food filling the first cavity.

9. The refillable pet toy of claim 8, wherein the pet food is frozen.

10. A refillable pet treat, comprising:
a rigid housing having a first face and a second face;
a first cavity in the first face of the rigid housing; and
a second cavity in the rigid housing.

11. The refillable pet treat of claim 10, wherein the first cavity is filled with a pet food.

12. The refillable pet treat of claim 11, wherein the housing is inedible.

13. The refillable pet treat of claim 10, wherein the first cavity has a perimeter to area ratio that is greater than a circle with the perimeter of the first cavity.

14. The refillable pet treat of claim 11, wherein the pet food is frozen.

15. A method of creating a refillable pet treat, comprising the steps of:
creating a rigid housing;
forming a first cavity in the rigid housing;
filling the first cavity of the rigid housing with a pet food; and
freezing the pet food.

16. The method of claim 15, wherein the step of filling the first cavity includes the step of selecting a ground pet food.

17. The method of claim 15, wherein the step of forming the first cavity includes the step of forming a second cavity in the first cavity.

18. The method of claim 17, further including the step of forming the second cavity so that a perimeter to area ratio is greater than a circle with the perimeter of the second cavity.
